(19) United States
(12) Patent Application Publication
(10) Pub. No.: US 2013/0143098 A1
(43) Pub. Date: Jun. 6, 2013

(54) LITHIUM ION BATTERY AND CASING FOR THE SAME

(71) Applicants: Jen-Chin Huang, New Taipei City (TW); Yu Zeng, Changshu City (CN)

(72) Inventors: Jen-Chin Huang, New Taipei City (TW); Yu Zeng, Changshu City (CN)

(73) Assignees: GOLDEN CROWN NEW ENERGY (HK) LIMITED, Kowloon (HK); SUZHOU GOLDEN CROWN NEW ENERGY CO., LTD., Changshu City (CN)

(21) Appl. No.: 13/362,081

(22) Filed: Jan. 31, 2012

(30) Foreign Application Priority Data
Dec. 2, 2011 (CN) 201110395144.8

(51) Int. Cl. H01M 2/02; H01M 10/02

(52) U.S. Cl. 429/153; 429/163

(57) ABSTRACT

A casing for a lithium ion battery is formed by a piece of metal sheet. The casing includes a bottom wall and a plurality of side walls extending upwardly from the bottom wall to define a top opening opposite to the bottom wall. The plurality of side walls includes at least two opposite side walls, each defining a recess region recessing inwards therefrom. The recess region has a symmetrical shape.

### CROSS-REFERENCE TO RELATED APPLICATION

This application claims priority to and the benefit of, pursuant to 35 U.S.C. §119(a), Chinese patent application No. 201110395144.8, filed Dec. 2, 2011, entitled “LITHIUM ION BATTERY AND CASING FOR THE SAME”, by Jen-Chin Huang and Yu Zeng, the content of which is incorporated herein by reference in its entirety.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference were individually incorporated by reference.

### FIELD OF THE INVENTION

The present invention generally relates to a rechargeable battery, and more particularly to a lithium ion battery.

### BACKGROUND OF THE INVENTION

Generally, rechargeable batteries can be charged or discharged numerous times in comparison with conventional primary batteries which cannot be charged. Nowadays, lithium (Li) batteries, lithium ion batteries, and Ni-MH batteries are widely used as rechargeable battery. The rechargeable battery is usually classified into a liquid electrolyte battery and a polymer electrolyte battery based on the electrolyte used in the battery. Typically, the lithium ion battery is a liquid electrolyte battery. In the art, the lithium ion battery is manufactured in various shapes, such as cylindrical, rectangular, and pouch shapes.

Usually, the shape of the lithium ion battery has a great effect upon the design and manufacturing of the cell structure. For example, the cylindrical battery generally has a winded cell core structure, while, for a rectangular shape battery, a plurality of stacked electrode plates constitute a cell core structure. Currently, there are several methods to manufacture the stacked electrode plates or cell core structure for rectangular battery. For example, Chinese Patent No. 101485033 discloses a Zigzag method. Chinese Patent No. 101174681 discloses an insulator-bagging method. Chinese Patent No. 101405911 discloses an insulator-sectioning method.

For the Zigzag method, the positive pole and the negative pole are formed by plating positive/negative material on the plate and employing electrode ears connecting thereto, respectively. A separator will be positioned between neighbored two plates for insulation purposes. If the positive electrode ear and the negative electrode ear face the same direction, the corresponding terminals, which are attached to a cap of the battery, will be located at the same side. Consequently, the designs of insulation and connection for the cap and the cell core structure of the battery are relatively important.

Generally, a typical rectangular battery employing the Zigzag method has a high content density compared to a cylindrical battery. Such a typical rectangular battery always comprises a metal shell made of steel or aluminum, which is integrally formed by stamping and sketching. However, mechanical strength in the middle portion of the metal shell is weak. When the battery is repeatedly used for a long period of time, the battery is subject to undesired deformation, such as a battery bulge failure in some cases, thereby shortening the service life of the battery.

Therefore, a heretofore unaddressed need exists in the art to address the aforementioned deficiencies and inadequacies.

### SUMMARY OF THE INVENTION

One aspect of the present invention provides a casing for a lithium ion battery. The casing includes a bottom wall and a plurality of side walls extending upwardly from the bottom wall to define a top opening opposite to the bottom wall, where the casing is formed by a piece of metal sheet. The plurality of side walls include at least two opposite side walls. Each opposite side wall defines a recess region recessing inwards therefrom, and the recess region has a symmetrical shape.

In one embodiment, the at least two opposite side walls respectively have larger area than the other side walls without the recess regions.

In one embodiment, each recess region has a central part overlapping with a central part of the corresponding side wall on which the recess region is defined.

In one embodiment, the recess region can be a rectangular recess. In an alternative embodiment, the recess region can include a plurality of parallel-extended linear recesses. In an alternative embodiment, the recess region can include a plurality of transversal linear recesses and a plurality of longitudinal linear recesses arranged in a staggered pattern. In an alternative embodiment, the recess region can include a plurality of rectangular grooves arranged in matrix arrays. In an alternative embodiment, the recess region can include a plurality of circular grooves arranged in matrix arrays.

In one embodiment, a length and a width of each recess region are ⅓-⅔ of those of the corresponding side wall on which the recess region is defined.

In one embodiment, a length and a width of each recess region are ½ of those of the corresponding side wall on which the recess region is defined.

In another aspect, a lithium ion battery is provided. The lithium ion battery includes a casing, and the casing includes a bottom wall and a plurality of side walls extending upwardly from the bottom wall to define a top opening opposite to the bottom wall, where the casing is formed by a piece of metal sheet. The plurality of side walls includes at least two opposite side walls. Each opposite side wall defines a recess region recessing inwards therefrom, and the recess region has a symmetrical shape.

In one embodiment, the lithium ion battery further includes a cell assembly having a plurality of parallel stacked positive electrode plates and negative electrode plates.

In one embodiment, the positive electrode plates and the negative electrode plates are parallel to the at least two opposite side walls on which the recess region is defined.

In one embodiment, the lithium ion battery further includes a cover covering the top opening of the casing.

In one embodiment, the at least two opposite side walls respectively have larger area than the other side walls without the recess regions.

In one embodiment, each recess region has a central part overlapping with a central part of the corresponding side wall on which the recess region is defined.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a perspective view of a lithium ion battery in accordance with an embodiment of the present invention;

FIG. 2 is a front view of the lithium ion battery;

FIG. 3 is a schematic view showing a recess region having a different shape;

FIG. 4 is a schematic view a recess region having another different shape;

FIG. 5 is a schematic view a recess region having still another different shape;

FIG. 6 is a schematic view a recess region having still another different shape; and

FIG. 7 is a partial enlarged view of the lithium ion battery.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

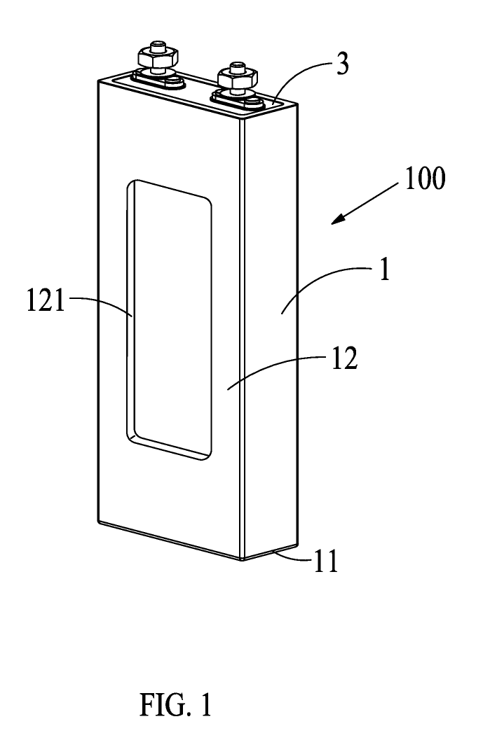

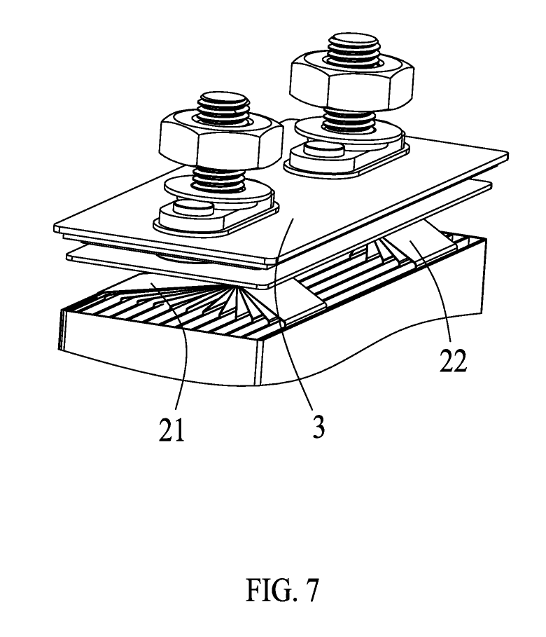

The description will be made as to the embodiments of the present invention in conjunction with the accompanying drawings in FIGS. 1-7. In accordance with the purposes of this invention, as embodied and broadly described herein, this invention, in one aspect, relates to a lithium ion battery and a casing for the same.

Referring to FIGS. 1-7, a lithium ion battery 100 is shown as a rectangular lithium ion battery according to one embodiment of the present invention, which is usable for a power source of an external device. The lithium ion battery 100 includes a casing 1, a cell assembly received in the casing 1, and a cover 3 covering a top opening defined in the casing 1. As can be understood, electrolyte is filled within the casing 1. The cell assembly includes a plurality of positive electrode plates 21, a plurality of negative electrode plates 22, and a plurality of insulating separators (not labeled) sandwiched between every two adjacent electrode plates. Details known by the persons of ordinary skills in the art will not described hereinafter.

The casing 1 can be formed by, but not limited to, stamping from a piece of metal sheet. The casing 1 includes a bottom wall 11 and a plurality of side walls 12 extending perpendicularly upwards from the bottom wall 11 to define the top opening opposite to the bottom wall 11. The casing 1 has a rectangular cross section. A pair of opposite walls 12 respectively have larger area than the other two side walls, and each defines a recess region 121 recessing inwards therefrom. The recess region 121 has a symmetrical shape and extends parallel to the electrode plates 21, 22.

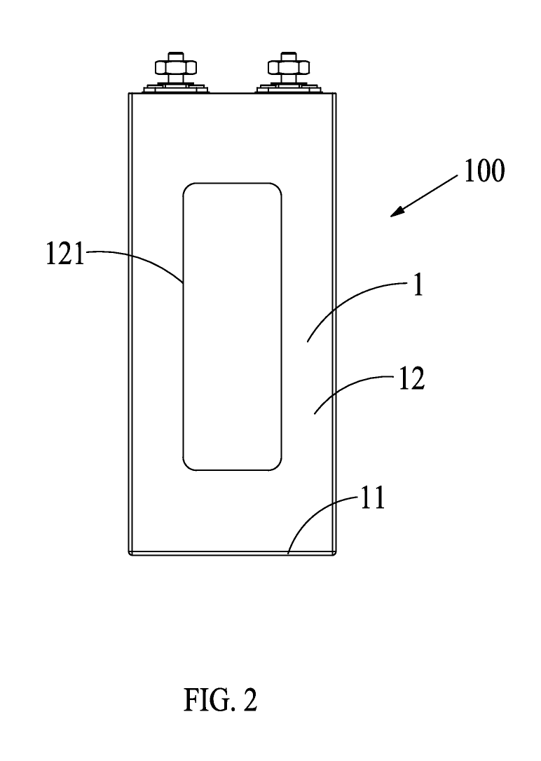

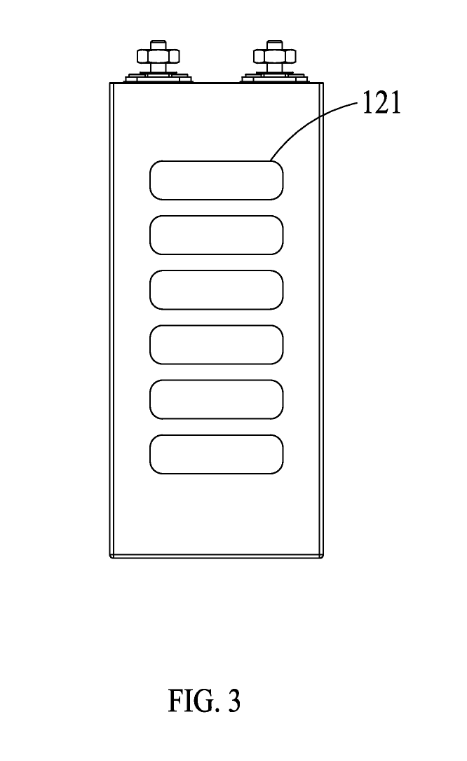

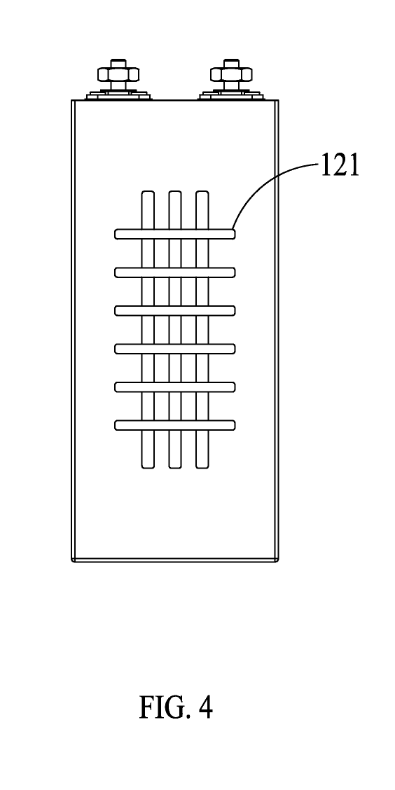

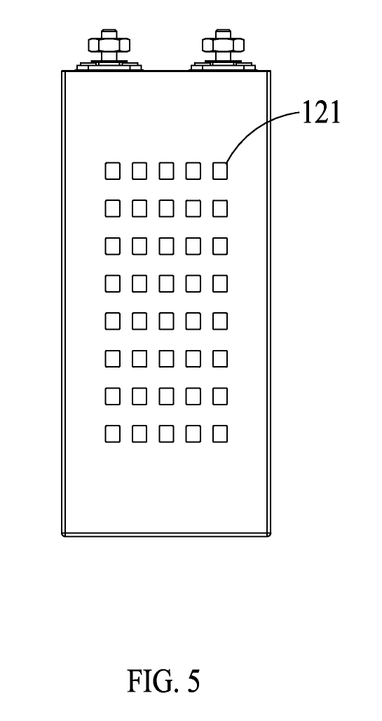

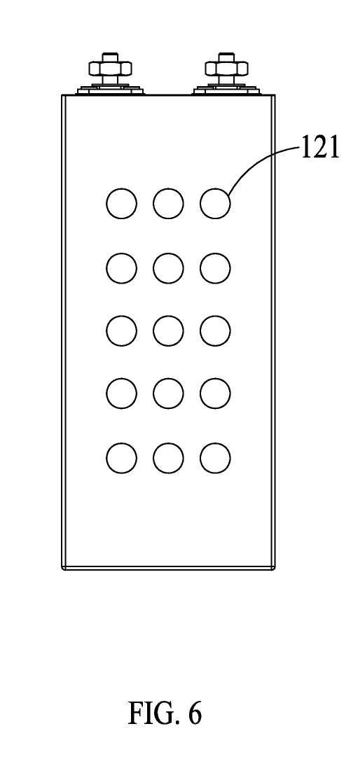

Referring to FIGS. 1 and 2, in one embodiment, the recess region 121 has a rectangular shape. A length and a width of the recess region 121 is ⅓-⅔ of those of the side wall 12 on which said recess region 121 is defined. In a further embodiment, the length and width of the recess region 121 can be ½ of those of the side wall 12. The recess region 121 can have various shapes or configurations. Referring to FIGS. 3-6, many kinds of recess regions 121 are shown. In one embodiment, the recess region 121 can be composed by a plurality of parallel arranged linear recesses, as shown in FIG. 3. In one embodiment, the recess region 121 can include a plurality of transversal linear recesses and a plurality of longitudinal linear recesses arranged in a staggered pattern, as shown in FIG. 4. In one embodiment, the recess region 121 can be a plurality of rectangular recesses or a plurality of circular grooves arranged in matrix arrays, as shown in FIG. 5 or FIG. 6. It should be emphasized that the recess region 121 has a symmetrical shape, particularly a central symmetrical shape. The central part of the recess region 121 is at least partially overlapped with the central part of the side wall 12 on which the recess region 121 is defined.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. A casing for a lithium ion battery, comprising:
a bottom wall and a plurality of side walls extending upwardly from the bottom wall to define a top opening opposite to the bottom wall;
wherein the casing is formed by a piece of metal sheet, and the plurality of side walls comprises at least two opposite side walls, each opposite side wall defining a recess region recessing inwards therefrom, the recess region having a symmetrical shape.

2. The casing as claimed in claim 1, wherein the at least two opposite side walls respectively have larger area than the other side walls without the recess regions.

3. The casing as claimed in claim 1, wherein each recess region has a central part overlapping with a central part of the corresponding side wall on which the recess region is defined.

4. The casing as claimed in claim 3, wherein the recess region is a rectangular recess.

5. The casing as claimed in claim 3, wherein the recess region comprises a plurality of parallel-extended linear recesses.

6. The casing as claimed in claim 3, wherein the recess region comprises a plurality of transversal linear recesses and a plurality of longitudinal linear recesses arranged in a staggered pattern.

7. The casing as claimed in claim 3, wherein the recess region comprises a plurality of rectangular grooves arranged in matrix arrays.

8. The casing as claimed in claim 3, wherein the recess region comprises a plurality of circular grooves arranged in matrix arrays.

9. The casing as claimed in claim 3, wherein a length and a width of each recess region are ⅓-⅔ of those of the corresponding side wall on which the recess region is defined.

10. The casing as claimed in claim 3, wherein a length and a width of each recess region are ½ of those of the corresponding side wall on which the recess region is defined.

11. A lithium ion battery, comprising:
a casing, comprising a bottom wall and a plurality of side walls extending upwardly from the bottom wall to define a top opening opposite to the bottom wall, wherein the casing is formed by a piece of metal sheet;
wherein the plurality of side walls comprises at least two opposite side walls, each opposite side wall defining a recess region recessing inwards therefrom, the recess region having a symmetrical shape.

12. The lithium ion battery as claimed in claim 11, further comprising a cell assembly having a plurality of parallel-stacked positive electrode plates and negative electrode plates.

13. The lithium ion battery as claimed in claim 12, wherein the positive electrode plates and the negative electrode plates are parallel to the at least two opposite side walls on which the recess region is defined.

14. The lithium ion battery as claimed in claim 13, further comprising a cover covering the top opening of the casing.

15. The lithium ion battery as claimed in claim 11, wherein the at least two opposite side walls respectively have larger area than the other side walls without the recess regions.

16. The lithium ion battery as claimed in claim 11, wherein each recess region has a central part overlapping with a central part of the corresponding side wall on which the recess region is defined.
